(19) United States
(12) Patent Application Publication
(10) Pub. No.: US 2010/0077954 A1
(43) Pub. Date: Apr. 1, 2010

(54) Removable gas line marker system

(75) Inventor: David J. Eigel, North Canton, OH (US)

Correspondence Address: SAND & SEBOLT, AEGIS TOWER, SUITE 1100, 4940 MUNSON STREET, NW, CANTON, OH, 44718-3615, US

(73) Assignee: UTILITY PIPELINE, LTD., NORTH CANTON, OH (US)

(21) Appl. No.: 12/286,621

(22) Filed: Oct. 1, 2008

(51) Int. Cl. G01D 21/00

(52) U.S. Cl. 116/209; 248/530

(57) ABSTRACT

A marker post system for marking the location underground pipelines includes marker post holder which removably holds a marker post. The marker post holder is configured for releasable connection with an underground tube. Removal of the holder from the tube provides manual access to the interior chamber of the tube to facilitate cleaning the interior chamber and removing a broken segment of a marker post which otherwise would be difficult without digging up the tube. A substantially watertight seal is preferably provided between the holder and marker post to prevent water from entering the interior chamber of the underground tube.

### BACKGROUND OF THE INVENTION

1. Technical Field

The present invention relates generally to a marker system for an underground gas line or other pipeline. More particularly the invention relates to such a marker system which includes an underground holder assembly in which a marker post is removably inserted.

2. Background Information

Underground pipelines are well known for transferring therethrough gasses and liquids. It is also well known to provide marker posts which are secured to and extend above the ground near the underground pipeline in order to mark the approximate location of the pipeline. It is also well known to utilize a marking wire which is buried along with the pipeline and extends generally along its length with access wires connected to the marking wire and extending upwardly therefrom to the surface of the ground adjacent the marker post to provide terminals to facilitate determining the location of the underground at pipeline positions distal the marker post. More particularly, a worker will connect an electrical source to the access wires via the terminals to produce an electrical charge in the wire and then use a sensor to track the location of the wire and thus the pipeline, for example up to 500 feet away from the access wire and marker post. Although removable marker posts are known in the art, as shown for example in U.S. Pat. No. 4,649,678 granted to Lamson, there is some room for improvement. One of the problems relates to the holder of the marker post becoming clogged with dirt and other debris which can make insertion and removal of the marker post more difficult or impossible at some point. In addition, rain water typically seeps into the holder, which can cause a problem for example when the water freezes and causes damage to the holder and/or make it difficult to remove the marker post. The present marker system addresses these and other problems in the art.

### BRIEF SUMMARY OF THE INVENTION

The present invention provides a marker system comprising: a marker post holder; a passage formed in the holder and having an upperentrance opening; the passage adapted to removably receive therein a marker post via the upper entrance opening; and a first connector member carried bythe holder and adapted for releasably connecting the holder to a tube with a portion of the holder extending over an upwardly opening interior chamber formed in the tube; the tube adapted to be positioned underground with its interior chamber communicating with above ground atmosphere.

The present invention also provides a marker system comprising: a tube defining an interior chamber having an upper entrance opening; the tube adapted to be positioned underground with its interior chamber communicating with above ground atmosphere; a marker post holder releasably connected to the tube and comprising a portion extending over the interior chamber; a passage formed in the holder adjacent the upper entrance opening; and an annular sealing member forming a substantially watertight seal with the holder and defining a through opening which communicates with the passage and is adapted to receive therethrough the marker post to form a substantially watertight seal with the marker post.

The present invention further provides a marker system comprising a tube defining an interior chamber having an upper entrance opening; the tube adapted to be positioned underground with its interior chamber communicating with above ground atmosphere; a marker post holder releasably connected to the tube and comprising a portion extending over the interior chamber; a passage formed in the holder adjacent the upper entrance opening; and a plurality of engaging members within the interior chamber adapted to engage a marker post inserted into the interior chamber via the passage.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a side elevational view of a first embodiment of the marker system of the present invention shown mounted in the ground adjacent an underground pipeline.

FIG. 2 is a top plan view of a first embodiment of the insert or holder of the present invention.

FIG. 3 is a side elevational view of the first embodiment of the insert or holder.

FIG. 3A is a sectional view taken on line 3A-3A of FIG. 2.

FIG. 4 is a bottom plan view of the connector collar of the present invention.

FIG. 5 is a side elevational view of the connector collar.

FIG. 6 is an enlarged sectional view of the first embodiment of a marker system from the side with portions cut away showing the marker post inserted into the holder and underground tube.

FIG. 7 is an enlarged sectional view of the encircled portion of FIG. 6.

FIG. 8 is similar to FIG. 6 and shows the marker post having been broken off.

FIG. 9 is a top plan view of the marker system and the broken off marker post shown in FIG. 8 and illustrating the holder being rotated between secured and unsecured positions.

FIG. 10 is an enlarged side elevational view of the upper portion of the first embodiment of the marker system showing the holder being removed upwardly from within the underground tube.

FIG. 10A is similar to FIG. 8 and shows insertion of a hand into the underground tube after removal of the marker post holder in order to remove a broken segment of the marker post from within the underground tube.

FIG. 11 is a side elevational view similar to FIG. 1 showing a second embodiment of the marker system of the present invention.

FIG. 12 is a top plan view of a second embodiment of the holder of the present invention.

FIG. 12A is an enlarged top plan view of a portion of the second embodiment of the marker post holder illustrating the seal receiving recess and passage thereof in greater detail.

FIG. 13 is a side elevational view of the second embodiment of the holder.

FIG. 14 is a side elevational view of the second embodiment of the holder rotated 90° from the position shown in FIG. 13.

FIG. 15 is a sectional view taken on line 15-15 of FIG. 11 of a second embodiment of the marker post.

FIG. 16 is a sectional view similar to FIG. 15 of a third embodiment of the marker post.

FIG. 17 is a perspective view of the seal which is used with the marker post shown in FIGS. 11 and 15.

FIG. 18 is a sectional view taken on line 18-18 of FIG. 11 showing the anti-rotation cuff in a top plan view.

FIG. 19 is a sectional view taken on line 19-19 of FIG. 11.

FIG. 20 is an enlarged sectional view of the encircled portion of FIG. 19.

FIG. 21 is a sectional view similar to FIG. 19 taken from the front and thus along a line which is 90 degrees relative to the view shown in FIG. 19.

FIG. 22 is a sectional view taken on line 22-22 of FIG. 21 showing the second embodiment of the marker post inserted through the second embodiment of the seal into the second embodiment of the holder.

FIG. 23 is similar to FIG. 22 and shows the third embodiment of the marker post inserted through the third embodiment of the seal into the second embodiment of the holder.

Similar numbers refer to similar parts throughout the drawings.

### DETAILED DESCRIPTION OF THE INVENTION

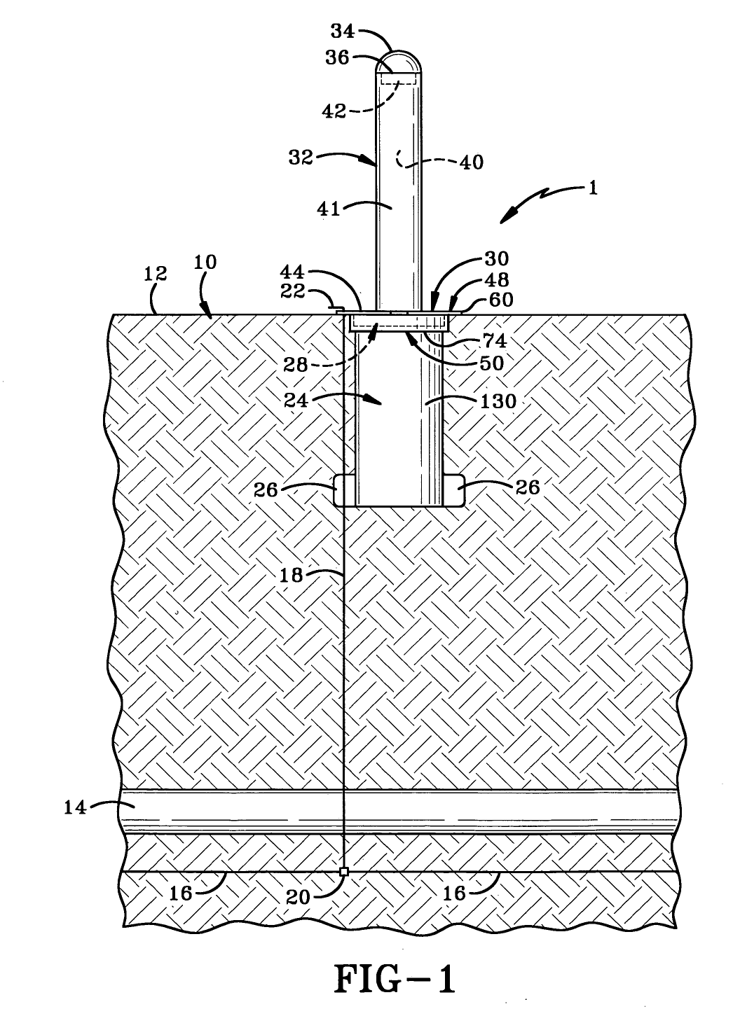

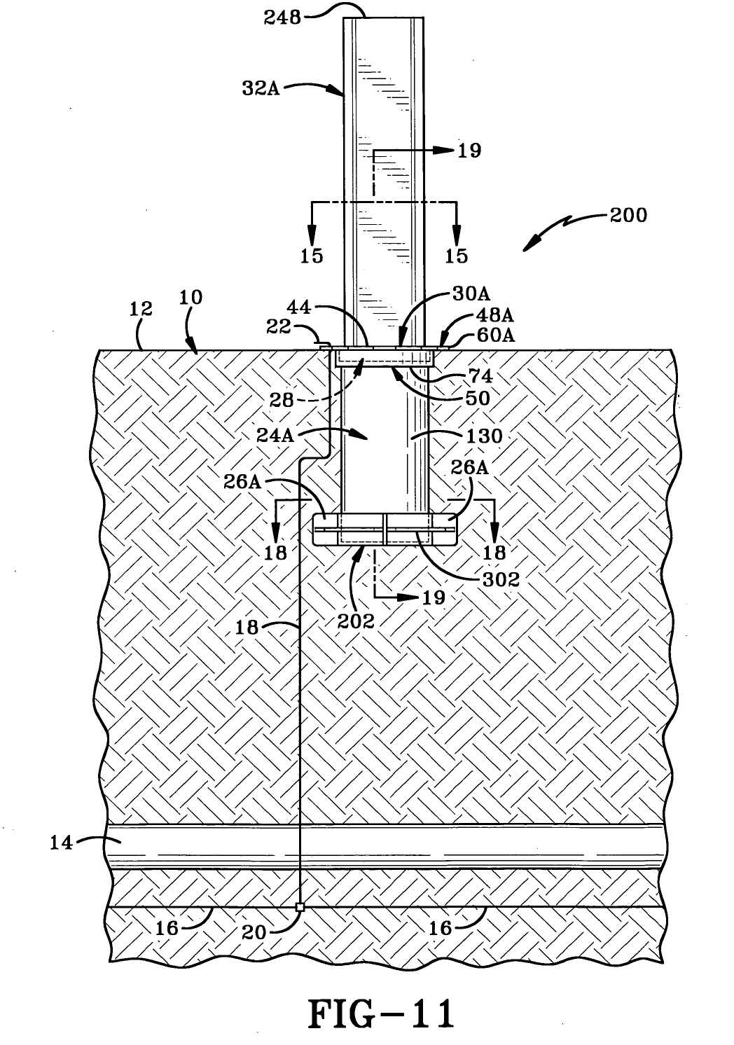

The first embodiment of the marker system of the present invention is shown generally at 1 in FIG. 1; and the second embodiment of the marker system is shown at 200 in FIG. 11. Systems 1 and 200 are configured to provide above ground marker posts at various locations along an underground pipeline in order to facilitate determining the location of the pipeline, for instance when it needs to be checked for repair or in order to ensure that digging in the vicinity of the pipeline does not damage it. As noted in the Background section of the present application, such pipelines are configured for transporting liquids or gasses therethrough such as natural gas which is used for commercial and residential purposes.

FIG. 1 shows marker system 1 mounted in ground 10 so that part of it extends below and part of it extends above the upper surface 12 of ground 10. System 1 is positioned directly above or generally above and adjacent an underground pipeline 14. An electrically conductive locator wire 16 is buried alongside pipeline 14 and runs generally parallel thereto and may extend several hundred feet. An access wire or terminal wire 18 is connected somewhere along the length of locator wire 16 at electrical connection 20 and extends upwardly to an upper end to provide an electrical terminal 22 which is above and adjacent surface 12 of ground 10. As described in the Background section, a worker can connect an electrical source terminal 22 in order to produce an electrical charge in wires 18 and 16 whereby a suitable sensor is used to track locator wire 16 and thus find the approximate location of underground pipeline up to 500 feet away from terminal 22 and marker system 1.

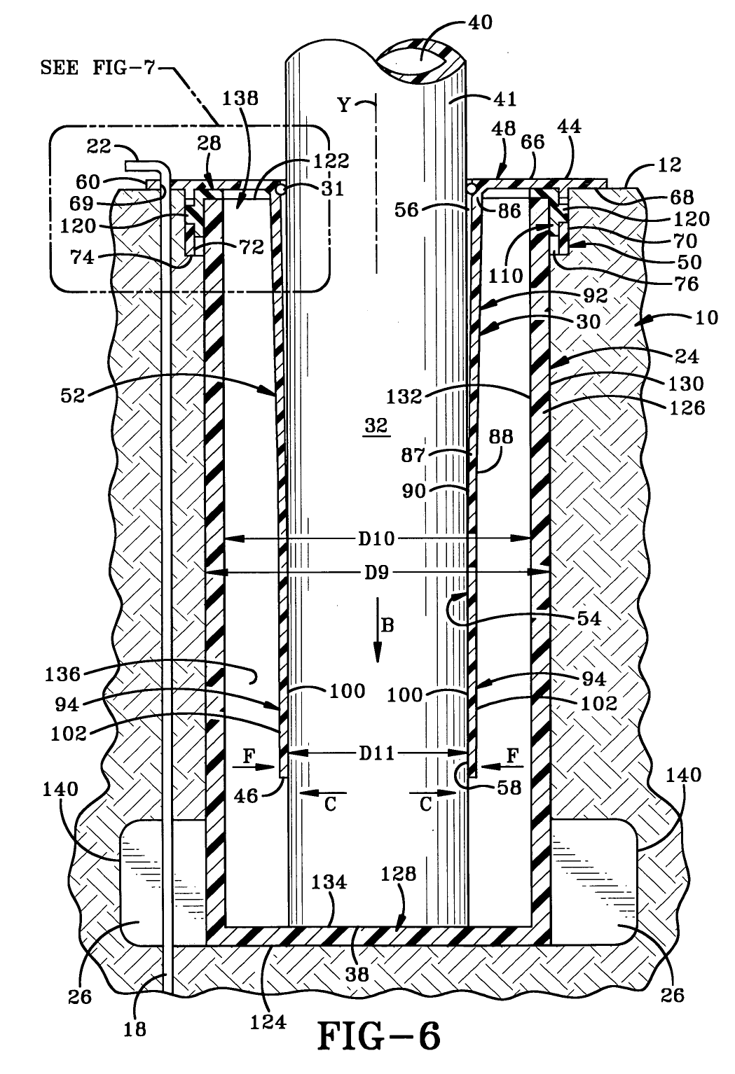

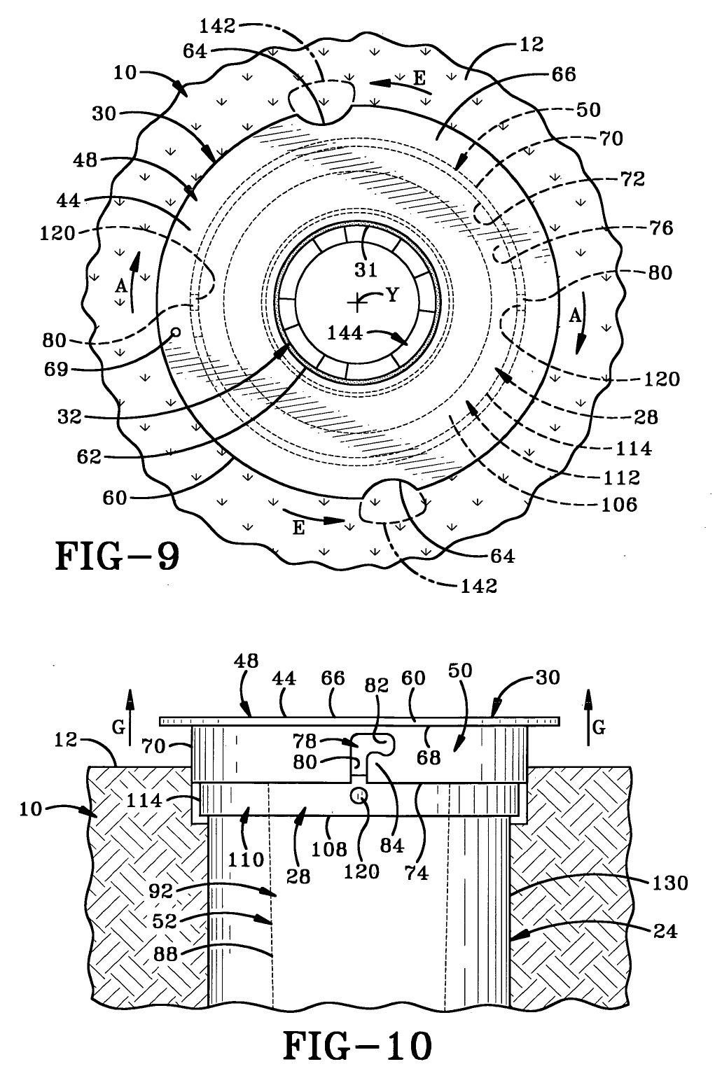

With continued reference to FIG. 1, marker system 1 includes an underground pipe or tube 24, anti-rotation projections or fins 26 secured to and extending outwardly therefrom, a connector collar 28 secured to the top of tube 24, a marker post holder 30 which is removably connected to collar 28, an annular seal or sealing member 31 (FIGS. 6, 9) which is mounted adjacent the top of holder 30, a marker post 32 which is removably received within post holder 30, sealing member 31 and underground tube 24, and a cap 34 mounted atop post 32. These various components of system 1 are most preferably formed of materials which are water impermeable and non-rusting or non-corroding. In addition, holder 30, sealing member 31, marker post 32 and cap 34 in particular are preferably formed of materials which are resistant to degradation by ultraviolet (UV) light inasmuch as these components will typically be exposed to sunlight when system 1 is installed. Tube 24, fins 26, collar 28, holder 30, post 32 and cap 34 are typically formed of substantially rigid materials and most typically are formed of a suitable plastic material. Sealing member 31 is typically formed of rubber or another elastomer.

Post 32 in the exemplary embodiment has a tubular structure and more particularly is typically cylindrical. Post 32 has a top end 36 and a bottom end 38 (FIG. 6) and defines a through passage 40 extending from end 36 to end 38. Marker post 32 has an outer surface 41 which is substantially cylindrical and extends from upper end 36 to bottom end 38. In order to prevent water from entering passage 40 through top end 36, cap 34 is secured to top end 36. Cap 34 is shown in FIG. 1 as having a dome shaped upper surface although any suitable top wall or cap will suffice in order to prevent water from entering passage 40. Cap 34 may include an insert portion 42 which is inserted into passage 40 at top end 36 in order to help secure cap onto tube 32. The outer diameter of insert portion 42 may be configured to provide a tight friction fit with the inner surface of tube 32 in order to secure cap 34 without the use of glue or other fasteners. However, cap 34 may be secured to post 32 by any suitable manner known in the art, including glue, sonic welding and so forth preferably to form a substantially water tight connection therebetween.

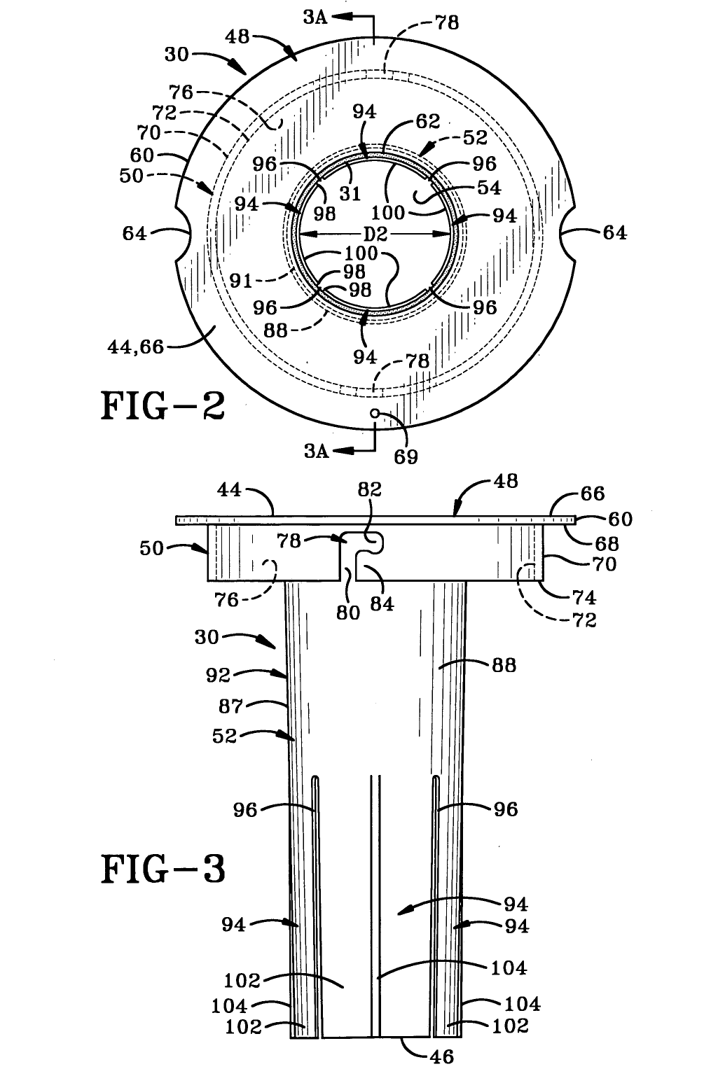

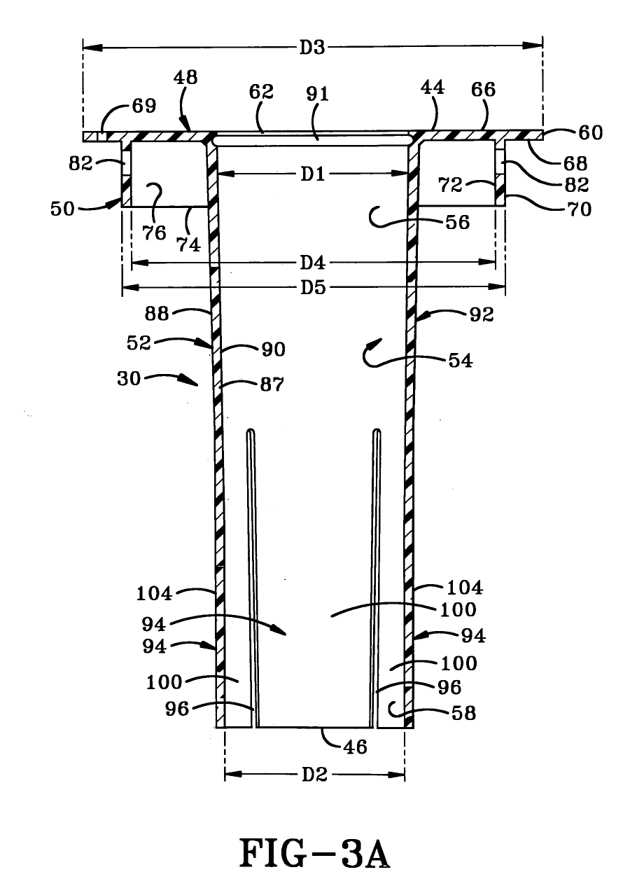

With primary reference to FIGS. 2 and 3, marker post holder 30 is described in further detail. Holder 30 has a top 44 and a bottom 46. Holder 30 includes a substantially flat horizontal annular and generally circular top cover wall 48, an annular and typically cylindrical connector wall 50 which is rigidly secured to and extends downwardly from cover wall 48, and an insert portion 52 which is also rigidly connected to and extends downwardly from cover wall 48 and is disposed radially inwardly of connector wall 50. Marker 30 defines a vertical marker post receiving through passage 54 which extends from top 44 to bottom 46 and through insert portion 52. Passage 54 is nearly cylindrical but tapers slightly downwardly and inwardly whereby passage 54 has a wider section 56 (FIG. 6) adjacent top 44 and a narrower section 58 adjacent bottom 46. Wider section 56 of passage 54 has a diameter D1 (FIG. 3A). Narrower section 58 has a diameter D2 which is only a little less than diameter D1. In the exemplary embodiment, diameter D2 is only about ⅛ to ⅜ inch less than diameter D1 although this may vary. Cover wall 48 has a substantially circular outer periphery 60 and a substantially circular inner periphery 62 which defines a top entrance opening of passage 54. Outer periphery 60 has a diameter D3 which is substantially larger than diameters D1 and D2 and in the exemplary embodiment is on the order of about 6 inches although this may vary.

A pair of cutouts or indentations 64 is formed on opposite sides of cover wall 48 extending respectively inwardly from outer periphery 60 in order to provide radially extending surfaces which serve as a manual grip to facilitate rotation of holder 30 about a vertical axis when in its upright position. A tool may also be specially configured to engage indentations 64 to facilitate this rotation. Cover wall 48 has a substantially flat annular upwardly facing top surface 66 and a parallel substantially flat annular downwardly facing bottom surface 68. A terminal wire hole 69 may be formed in upper wall 48 extending from top surface 66 to bottom surface 68 for receiving therethrough terminal wire 22 although this may be omitted.

Connector wall 50 is substantially circular or cylindrical and has a cylindrical outer surface 70 which faces radially outwardly and a circular inner surface 72 which faces radially inwardly. Inner surface 72 defines an inner diameter D4 of connector wall 50 which is notably greater than diameters D1 and D2 and notably less than diameter D3. In the exemplary embodiment, inner surface 72 is spaced outwardly from the upper outer surface of insert portion 52 by about 1.0 inch whereby inner diameter D4 is on the order of about 4-¾ inches although these dimensions may vary. Outer surface 70 defines an outer diameter of connector wall 50 which is larger than diameter D4 and less than diameter D6, and in the exemplary embodiment is on the order of about 5 inches. Wall 50 has an upper end connected to bottom surface 68 of cover wall 48 and extends vertically downwardly to a bottom terminal end 74. Inner surface 72 defines therewithin an annular cavity 76 bounded by the outer periphery of the upper portion of insert portion 52. Annular cavity 76 opens downwardly at an entrance opening defined by terminal end 74. Two L-shaped connector notches 78 are formed in connector wall 50 each extending from its outer surface 70 to its inner surface 72 and thus communicating with cavity 76. Each notch 78 includes an upwardly extending generally vertical portion 80 and a laterally extending generally horizontal portion 82 extending from the top of vertical portion 80 to define therebelow a connector tab 84 which serves as a connector member for securing holder 30 to connector collar 28 as described further below. Portion 80 has a bottom entrance opening at bottom end 74.

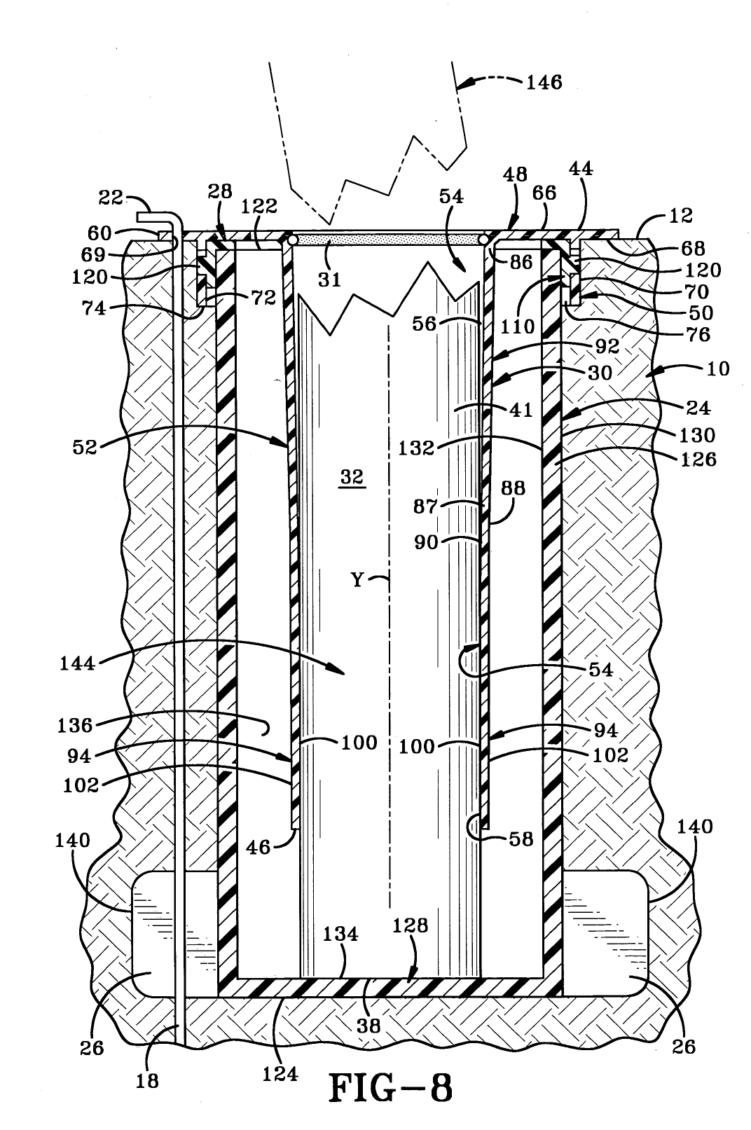

With continued reference primarily to FIGS. 2 and 3, insert portion 52 has a top end 86 (FIG. 6) which is secured to bottom surface 68 of cover wall 48 and extends downwardly to its bottom end which is represented by bottom end 46 of holder 30. Insert portion 52 has a generally tubular structure and includes an annular side wall 87 which is substantially cylindrical although it tapers downwardly and inwardly. Side wall 87 has an outer surface 88 which faces radially outwardly and an inner surface 90 which faces radially inwardly and defines nearly all of passage 54 with the exception of any portion of passage 54 defined by cover wall 48. An annular recess or groove 91 is formed in holder 30 extending around passage 54 adjacent surface 66 of upper wall 48. Thus as shown in FIG. 7, groove 91 is formed adjacent the intersection of cover wall 48 and side wall 87 and extends radially outwardly from inner surface 90 of side wall 87. Groove 91 is configured to receive therein sealing member 31 which in the exemplary embodiment is in the form of an 0-ring which is sufficiently flexible to flex inwardly and resilient to flex outwardly into groove 91 whereby it may be retained therein with or without an adhesive or glue. Holder 30 may also be formed with an annular recess which extends downwardly from top surface 66 and radially outwardly from inner surface 90 for receiving therein a modified annular sealing member having an adhesive on one side with a peel-off backing thereon as will be discussed later with regard to the embodiment shown in FIG. 17. Outer surface 88 adjacent top end 86 bounds or forms the inner boundary of cavity 76.

Side wall 87 includes a substantially cylindrical upper portion 92 and four engaging fingers 94 which are cantilevered downwardly from the bottom end of upper portion 92. Side wall 87 and thus insert portion 52 has a height from top to bottom which in the exemplary embodiment is about 8 inches with upper portion 92 and engaging fingers 94 each having a height of about 4 inches. While it is generally preferred that the height of insert portion 52 is at least 3 or 4 inches, it may be less than that, for example one to two inches or even less. The height of insert portion most typically falls within the range of about 3 to 4 inches to about 9 or 10 inches. Insert portion 52 may be formed without fingers 94 or may be formed substantially of fingers 94 and substantially without the cylindrical upper portion 92. However, upper portion 92 is typically in the range of about one to five or six inches while fingers 94 are also typically in the range of about one to five or six inches. Engaging fingers 94 are respectively separated by narrow vertical notches 96 each of which extends upwardly from bottom 46 to the bottom of upper portion 92, which is approximately midway between bottom 46 and top end 86. The four vertical notches 96 in the exemplary embodiment are circumferentially spaced from one another by about 90 degrees whereby each of the engaging fingers 94 extends circumferentially nearly 90 degrees. Fingers 94 are relatively thin as measured from outer surface 88 to inner surface 90. Each finger 94 has a pair of opposed circumferential vertical terminal edges 98 whereby the adjacent edges 98 of each adjacent pair of engaging fingers 94 defines therebetween one of notches 96. Each of fingers 94 is arcuate as viewed from above and thus inner surface 90 includes an arcuate surface 100 which curves concavely from one edge 98 of given finger 94 to its circumferentially opposite edge 98. Each of arcuate surfaces 100 in the exemplary embodiment forms an arc of a circle wherein each arc extends nearly but not quite 90 degrees. Outer surface 88 also includes an outer arcuate surface 102 of each engaging finger 94 which curves convexly and generally in a parallel fashion to inner arcuate surface 100. A vertical strengthening rib 104 is formed on each finger 94 extending radially outwardly from outer arcuate surface 102 midway between edges 98 of a given finger or midway between the corresponding notches 96. Strengthening ribs 104 thus provide additional strength to the relatively thin fingers 94. Although holder 30 is formed of a substantially rigid material, it nonetheless allows for the radially inward and outward flexing of the bottom ends 46 of fingers 94 due to their cantilevered and relatively thin configuration.

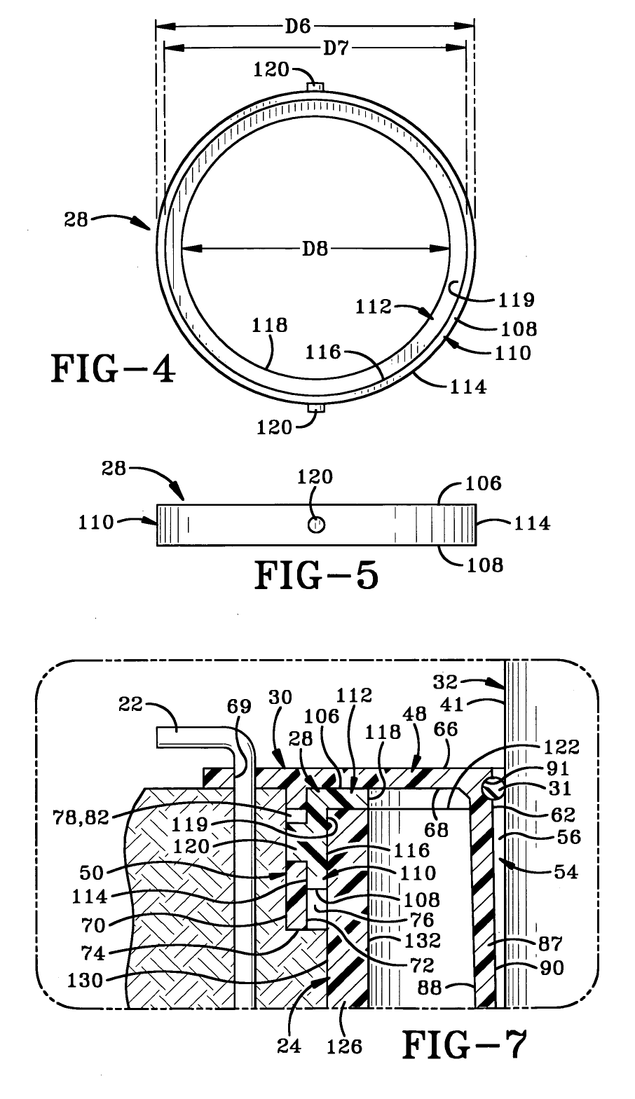

Connector collar 28 is now described in greater detail with primary reference to FIGS. 4 and 5. Collar 28 is a substantially circular annular member having a top 106, a bottom 108, a circular side wall 110 extending vertically from top 106 to bottom 108, and a circular horizontal top wall 112 which is rigidly connected to side wall 110 and extends radially inwardly therefrom a short distance. Side wall 110 has an outer periphery or surface 114 which defines an outer diameter D6. Side wall 110 also has an inner periphery or surface 116 which defines its inner diameter D7 which is somewhat smaller than outer surface D6. Top wall 110 has an inner periphery or surface 118 defining its inner diameter D8 which is smaller than diameter D7. Collar 28 defines an annular cavity 119 which extends radially inwardly from inner surface 116 of side wall 110 to inner surface 118 of top wall 112, and downwardly from the bottom of top wall 112 to bottom 108. In the exemplary embodiment, diameter D6 is on the order of about 4-¾ inches, diameter D7 is on the order of about 4-½ inches and inner diameter D8 is on the order of about 4 inches although these dimensions may vary. Outer diameter D6 is slightly smaller than inner diameter D4 of connector wall 50 so that (as shown in FIGS. 6-7) side wall 110 and top wall 112 may be slidably received upwardly into annular cavity 76 with outer surface 114 abutting or closely adjacent inner surface 72, so that top 106 of collar 28 is closely adjacent or abutting bottom 68 of cover wall 48, so that inner surface 118 is generally adjacent and spaced outwardly from outer surface 88 of side wall 87, and so that bottom 108 is adjacent and spaced upwardly of bottom 74 of connector wall 50, as best seen in FIG. 7. Connector collar 28 further includes a pair of opposed connecting members or projections in the form of posts 120 which are rigidly connected to and extend outwardly in opposite directions from outer surface 14 of side wall 110 a short distance. Posts 120 are configured to be respectively received within L-shaped notches 78, as described in greater detail further below.

With primary reference to FIG. 6, underground tube 24 is described in greater detail. Tube 24 has a top 122 and a bottom 124 and includes an annular and typical cylindrical side wall 126 and atypically flat circular bottom wall 128 which is rigidly secured to the bottom of side wall 126. Top 122 and bottom 124 of tube 24 define therebetween a height which is longer than the height of insert portion 52 and usually within the range of about 6 to 18 inches and more typically in the range of about 8 to 16 inches or 10 to 14 inches. Side wall 126 has a substantially cylindrical outer surface 130 and a substantially cylindrical inner surface 132. Bottom wall 128 has a typically circular flat upper surface 134 whereby inner surface 132 and upper surface 134 define therewithin a cavity or interior chamber 136 having an upper entrance opening of 138 at top 122. Inasmuch as interior chamber 136 extends nearly the entire height of tube 24, chamber 36 likewise has a height which is within the ranges noted above for the height of tube 24. Outer surface 130 defines an outer diameter D9 of side wall 126 which in the exemplary embodiment is on the order of about 4-½ inches and slightly smaller than diameter D7. Inner surface 132 defines an inner diameter D10 of side wall 126 which is in the exemplary embodiment on the order of about 4 inches and preferably substantially the same as inner diameter D8 of top wall 112 of collar 28. Inner diameter D10 is typically within the range of 3.5 to 5.0 inches and preferably is no less than about 3.5 inches. This dimension allows a person to insert his or her hand into interior chamber 136 in order to clean out any debris or water therein if necessary. Diameters D9 and D10 are nonetheless preferably kept as small as possible in order to minimize the amount of material used and thus the cost of the product. Anti-rotation projections or fins 26 extend outwardly from outer surface 130 of side wall 126 to respective terminal edges 140 whereby outer surface 130 and each edge 140 define therebetween a distance of about ½ inch to 2 inches and more typically about 1.0 to 1.5 inches. While the distance that fins 26 extend outwardly may vary, they are configured to prevent rotation of tube 24 about a vertical central axis Y as discussed further below and thus should extend sufficiently to achieve that purpose without extending outwardly any further than necessary. Fins 26 are preferably flat vertical plates so that their radially extending vertical side surfaces both serve the anti-rotation purpose although other projections may also serve this purpose.

As previously noted, connector collar 28 is rigidly secured to the top of tube 24. More particularly, top 122 of side wall 126 is slidably received within annular cavity 119 of collar 28 so that top 122 abuts the bottom of top wall 112 and outer surface 130 is closely adjacent or abuts inner surface 116 of side wall 110. Collar 28 is rigidly secured by glue, sonic welding or any other suitable fastening mechanism known in the art. When collar 28 is secured in this fashion, inner surface 118 and inner surface 132 are substantially vertically aligned with one another.

The operation and additional assembly of marker system 1 is now described with reference to FIGS. 6-10. Marker system 1 is typically installed generally at the time pipeline 14 is buried underground or when replacing other marker posts. To install marker system 1, a suitable hole is dug in ground 10 (FIG. 1) extending downwardly from surface 12 to a depth which is approximately the same as the height of underground tube 24 and collar 28 which is secured thereto as previously noted. Once this hole is dug, underground tube 24 and collar 28 are inserted downwardly therein and the dirt or other soil is packed around it to hold it securely in its underground position with top 122 and collar 28 adjacent surface of ground 10 and entrance opening 138 of interior chamber 136 in communication with atmosphere above surface 12 of ground 10. The installation of tube 24 and collar 28 may also include installing holder 30 if connected to collar 28 prior to the burial of tube 24. Alternately, holder 30 may be connected after the burial process.

In any case, the insert portion 52 is inserted downwardly through entrance opening 138 into interior chamber 136 of tube 24 so that posts 120 are respectively received upwardly into portions 80 of notches 78 until posts reach the top of portion 80 and are thus level with portion 82. Holder 30 is then rotated about vertical axis Y as indicated at Arrows A in FIG. 9 so that posts 120 are received within portions 82 above connector tabs 84 so that holder 30 is secured to collar 28 and tube 24. This rotation of holder 30 may be achieved manually either directly with fingers or with a specially configured tool which fits within indentations 64 of cover wall 48, said tool or fingers being denoted at 142 in FIG. 9. During rotation of holder 30 in the direction shown at arrows A, tabs 84 of collar 28 move respectively beneath posts 120. More particularly, each tab 84 includes an upwardly extending portion adjacent portion 80 having an upper surface which is slightly higher than the upper surface of tab 84 distal portion 80 whereby the higher surface of the projection during rotation slidably engages the bottom of the respective post 120 and subsequently helps prevent rotation of collar 28 in the opposite direction due to the relatively minor interference between the projection and post 120. Once posts 120 are received within portions 82, tabs 84 provide an interference with post 120 to prevent the upward movement of holder 30 relative to tube 24. During installation, terminal wire 22 may be threaded upwardly through hole 69 in cover wall 48 if hole 69 is provided.

When holder 30 is installed, a portion of bottom surface 68 of cover wall 48 which is disposed radially outwardly of connector wall 50 is closely adjacent or abutting surface 12 of ground 10. In addition, ground 10 typically abuts outer surface 70 of connector wall 50 as well as the portion of outer surface 130 of tube 24 therebelow and bottom surface 124. Cover wall 48 is generally flush with surface 12 of ground 10. In FIG. 6, bottom surface 68 of top wall 48 is shown abutting surface 12 and is thus at about the same height thereof. Inasmuch as cover wall 48 particularly has a thickness from top 66 to bottom 68 which is only on the order of about ⅛ inch, cover wall 48 in its entirety is typically substantially flush or closely adjacent surface 12. When post 32 is fully inserted, its bottom portion is disposed within interior chamber 136 whereby said bottom portion or segment has a height which is substantially the same as interior chamber 136. The upper portion of post 32 extends upwardly from holder 30 and surface 12 a distance of about 1 to 3 or 4 feet whereby the above ground portion of post 32 is visible and may generally be easily found by a worker trying to locate the post. In addition, the side wall of post 32 is substantially concentric about vertical axis Y, as are the various other circular structures of marker system 1, including side wall 87, engaging fingers 94, sealing member 31, groove or recess 91, cover wall 48 and its outer periphery 60, side wall 126 of tube 24, side wall 110 and top wall 112 of connector collar 28, and connector wall 50. FIG. 6 shows that bottom 46 is distal collar 28 and the top portions of holder 30 and tube 24 and generally adjacent bottom wall 128. FIG. 6 also shows that bottom 46 is spaced upwardly from top surface 134 of bottom wall 128 although it may be in contact therewith.

Once holder 30 is installed, marker post 32 may be removably inserted downwardly (arrow B in FIG. 6) into passage 54 via its upper entrance opening. When marker post 32 is fully inserted, a segment of post 32 extends along the full length of passage 54 and a segment therebelow extends downwardly from bottom 46 of fingers 94 below passage 54 so that bottom 38 is seated on top surface 134 of bottom wall 128. During the insertion, outer surface 41 of post 32 slidably engages the inner periphery of sealing member 31 as well as inner surface 88 of side wall 87, especially the inner arcuate surfaces 100 of engaging fingers 94. Outer surface 41 defines an outer diameter D11 (FIG. 6) which is slightly larger than diameter D2 of narrower section 58 and slightly smaller than diameter D1 of wider section 56 of passage 54. Thus, outer surface 41 of post 32 during its downward insertion causes the lower ends of fingers 94 via a camming engagement therewith to flexingly move transverse to the direction of insertion and radially outwardly as indicated at arrows C in FIG. 6 whereby fingers 94 due to their resilient properties apply a radially inward force (arrows F) on outer surface 41 after insertion of post 32. Force F is typically not very great and allows for the manual removal of post 32 by simply sliding it upwardly. With marker post 32 inserted, the inner surfaces of fingers 94 adjacent lower end 46 define therebetween a diameter which is substantially the same as diameter D11. Surfaces 100 have a mating configuration with outer surface 41 and thus provide therebetween a frictional engagement which lies substantially along a common circle. When marker post 32 is removed from interior chamber 136 and passage 54, the resilient nature of fingers 94 causes their lower ends to move radially inwardly toward axis Y back to their resting or home position illustrated in FIG. 3A. Inasmuch as inner surface 90 tapers downwardly and inwardly, the engagement between inner surface 90 and the outer service of marker post 32 is typically adjacent bottom 46 of fingers 94. However, the outer surface of marker post 32 may contact any portion of inner surface 90 from its top to its bottom. Since the engagement between the outer surface of marker post 32 and inner surface 90 is typically adjacent bottom 46, said engagement may thus be spaced downwardly from cover wall 48 a distance which falls within the ranges previously noted with regard to the height of insert portion 52, upper portion 92 or fingers 94.

In the exemplary embodiment, the inserted marker post 32 is in contact with other components of system 1 only at its seating engagement atop wall 128, its frictional engagement between inner surface 88 and outer surface 41, and its frictional sealing engagement between the inner periphery of sealing member 31 and outer surface 41. Thus, in the exemplary embodiment there are no other fasteners which secure post 32 in its inserted position or prevent its removal therefrom. In the inserted position, the inner periphery of sealing member 31 and the outer periphery 41 of post 32 form a substantially water tight seal. Likewise, sealing member 31 and the surface defining annular groove 91 also form a substantially water tight seal whereby external water is not allowed to pass beyond sealing member 31 into passage 54 and interior chamber 136. Connector wall 50 is preferably disposed radially outwardly of side wall 110 and top wall 112 of collar 82 as well as the top of side wall 126 whereby wall 50 helps prevent water from seeping into interior chamber 136 while also helping prevent soil from moving into chamber 136.

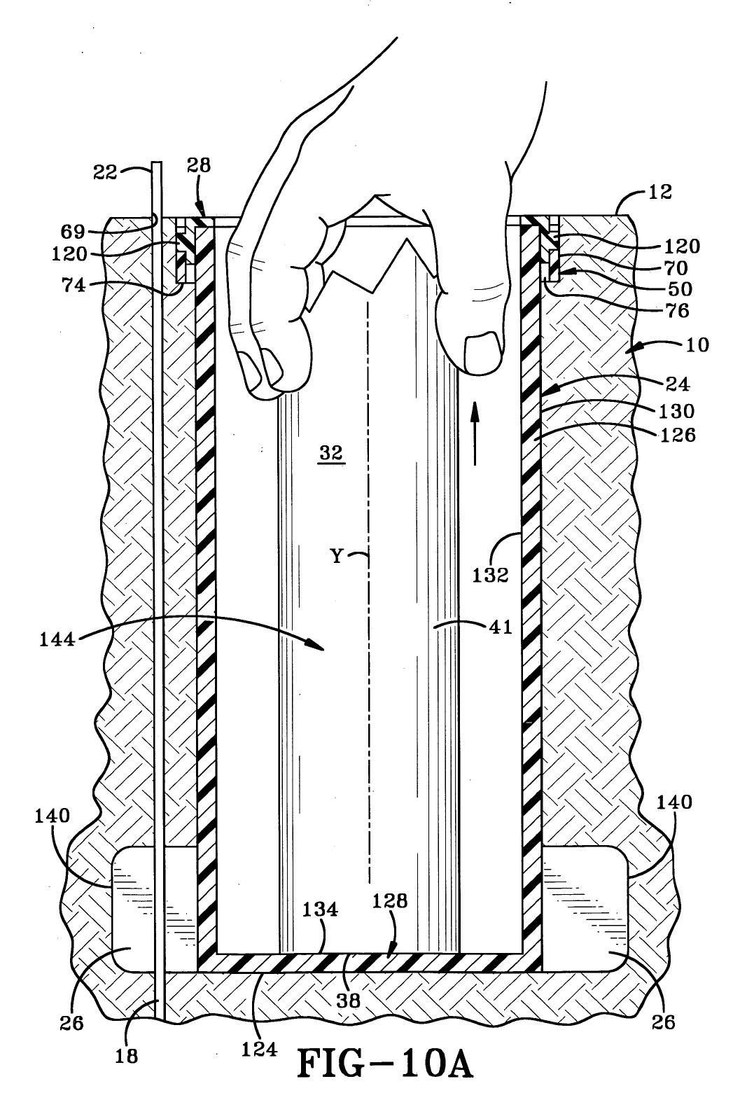

FIG. 8 represents a scenario when marker post 32 is broken into two or more pieces, and more particularly the scenario when marker post 32 is broken into a bottom piece or segment 144 and a top broken piece or segment 146 which is illustrated by dot—dash lines. This would normally occur when a lateral force is applied to the upper portion of post 32 and typically is caused by power machinery such as lawn mowers or other outdoor equipment accidentally forcefully engaging the upper portion of post 32. Such breakage often leaves the bottom segment 144 in a completely underground position (i.e., below surface 12 of ground 10) and belowtop surface 66 of coverwall 48. Broken segment 144 is thus often disposed entirely within passage 54 or nearly so such that it is difficult to manually grasp or otherwise engage segment 144 in order to remove it upwardly through the upper entrance opening of passage 54. However, marker system 1 is configured to overcome this problem. More particularly, as illustrated in FIG. 9, holder 30 is rotated via tool or fingers 142 about vertical axis Y in an unsecuring or releasing direction (arrows E) opposite the securing or connecting direction (arrows A). Rotation of holder 30 in the unsecuring direction allows posts 120 to exit portions 82 of notches 87 into the top of portions 80, thereby disengaging posts 120 from tabs 84. Holder 30 may then be moved vertically upwardly (arrow G in FIG. 10) so that posts 120 are removed from portions 80 and holder 30 is entirely removed from its connection to and insertion within underground tube 24. The removal of holder 30 allows access to interior chamber 136 of tube 24, which provides sufficient space for a worker to insert his or her hand (FIG. 10A) and grasp segment 144 to remove it (Arrow in FIG. 10A) from within chamber 136. Once broken segment 144 is removed from chamber 136, holder 30 may be reinserted chamber 136 and connected to collar 28 as previously discussed. Then a new marker post 32 make be inserted into passage 54 in order to replace the broken marker post with a new one. If holder 30 has been damaged, it also may be removed and replaced with a new holder 30. The hand shown in FIG. 10A is shown grasping segment 124 to remove it, but also illustrates the ability to insert a hand into interior chamber 136 in order to clean it out if any water, dirt or other debris has entered chamber 136. Marker system 1 is thus configured to allow for the removal and replacement of the marker post and/or the holder, and also allow for cleaning the inside of tube 24 without having to dig up tube 24 and either bury it again for subsequent use or replace it with another tube.

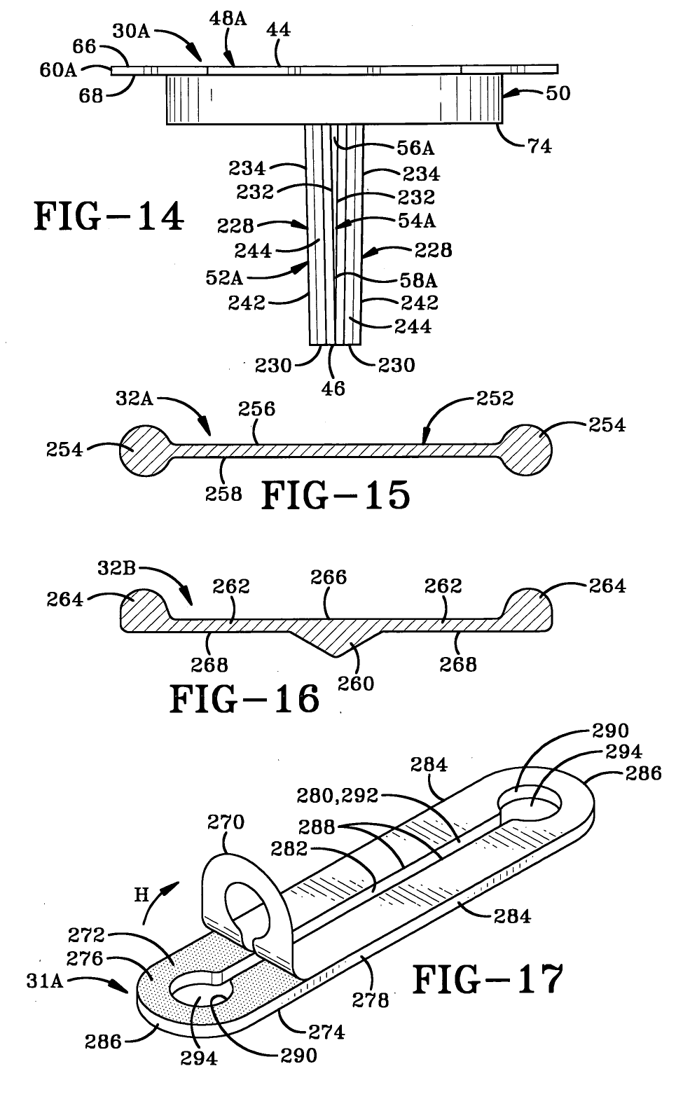

Marker system 200 serves the same purposes as marker system 1 and is shown in the same context in FIG. 11. System 200 is configured for use with a generally flat marker post such as marker post 32A, shown extending upwardly and substantially vertically in its operational configuration (FIG. 11) with its cross section shown in FIG. 15, and also with marker post 32B, the cross section of which is shown in FIG. 16. The overall configuration of marker system 200 is very similar to that of marker system 1 with various modifications. Thus, system 200 includes an underground tube 24A, anti-rotation fins 26A, connector collar 28, marker post holder 30A and sealing member 31A (FIGS. 17,19, 22). Fins 26A are substantially of the same configuration as fins 26 but are part of an anti-rotation cuff 202 which is secured to the bottom of the cylindrical portion of tube 24A to in part supply its bottom wall as discussed further below.

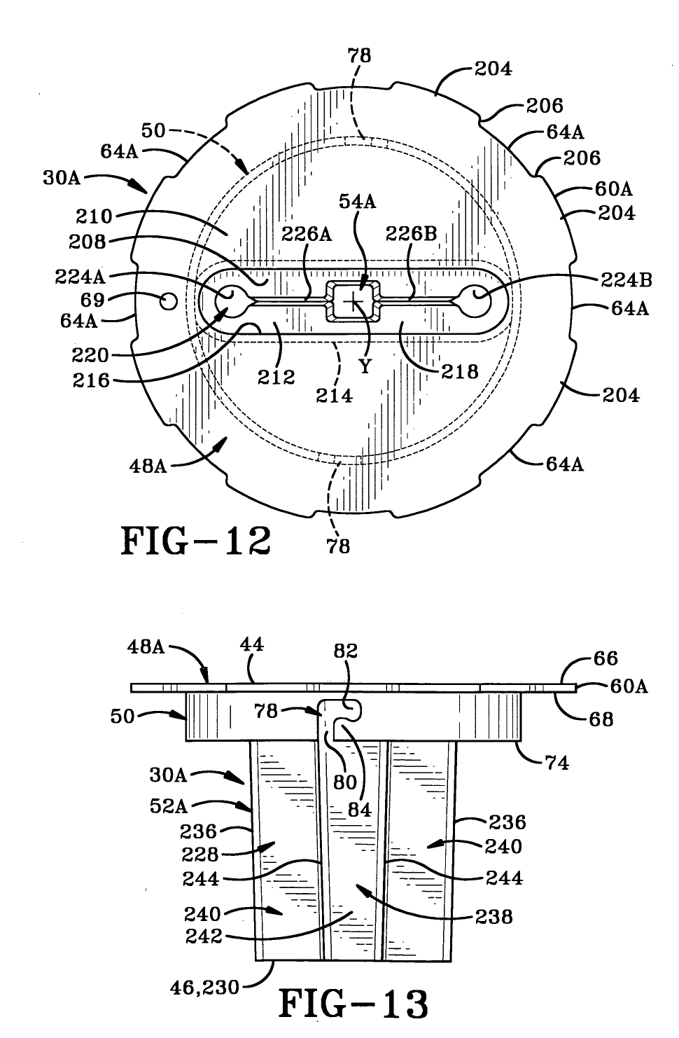

Marker post holder 30A is now described with primary reference to FIGS. 12-14. Like its counterpart, holder 30A includes a cover wall 48A which is very similar to cover wall 48, a connector wall 50 connecting to and extending downwardly from cover wall 48A, and an insert portion 52A connected to and extending downwardly from cover wall 48A inwardly of connector wall 50. Insert portion 52 defines therethrough a passage 54A which serves the same purpose as passage 54 of holder 30 but which has a different configuration for specific use with marker posts 32A and 32B, as described further below. Cover wall 48A has an outer periphery 60A which includes indentations 64A which alternate with outwardly extending projections or tabs 204 in order to define gripping surfaces 206 which extend radially outwardly as with indentations 64 of holder 30 in order to provide a surface to facilitate the rotation of holder 30 about central vertical axis Y. Cover wall 48A is substantially circular and flat and thus has flat top and bottom surfaces 66 and 68. A seal receiving recess 208 is formed in cover wall 48A extending downwardly from upper surface 66 and opening upwardly. Recess 208 is horizontally elongated and generally has a rectangular configuration with curved opposed ends. More particularly, cover wall 48 includes a generally circular flat horizontal top wall 210 which defines top and bottom surfaces 66 and 68, a flat horizontal recessed wall 212 which is recessed downwardly from top wall 210 a short distance, and an annular connecting wall 214 which is secured to and extends between top wall 210 and recessed wall 212 to join walls 210 and 212 to one another. Top wall 210 thus steps downwardly to recessed wall 212 at a generally vertical inner periphery 216 to an upwardly facing flat horizontal annular top surface 218 of recessed wall 212 which serves as the bottom boundary of recess 208 while inner periphery 216 circumscribes recess 208. Recessed wall 212 defines a specifically configured through opening 220 which communicates with and extends downwardly from recess 208 whereby recess 208 and opening 220 form the upper portion of or entrance opening of passage 54A.

Through opening 220 includes a generally rectangular central portion 222, a pair of opposed circular portions 224A and 224B which form opposed ends of opening 220 and two horizontal narrow straight portions 226A and 226B which extend respectively outwardly in opposite directions from central portion 222 respectively to circular portions 224A and 224B. Straight portions 226 are substantially collinear and lie along a vertical plane in which lies axis Y, which forms the center of rectangular portion 222 and through opening 220. Straight portions 226 thus extend radially outwardly in opposite directions from axis Y whereby circular portions 224 are spaced radially outwardly from axis Y and rectangular portion 222 on opposite sides of axis Y and portion 222. Circular portions 224 are generally adjacent and spaced radially inwardly from connector wall 50. Straight portions 226 are thus narrow and elongated so that rectangular portion 222 and circular portions 224 extend outwardly from sections 226 transverse to the elongated direction of sections 226. More particularly, each of portions 222 and 224 extends outwardly from portion 226 in opposite directions to either side of straight portions 226 whereby each of sections 222 and 224 is wider than sections 226 as measured perpendicular to the length of sections 226. In the exemplary embodiment, circular portions 224 extend only from the top of recessed wall 212 to the bottom of recessed wall 212 while rectangular portion 222 and straight portions 226 extend from the top of recessed wall 212 downwardly to bottom 46 of insert portion 52A.

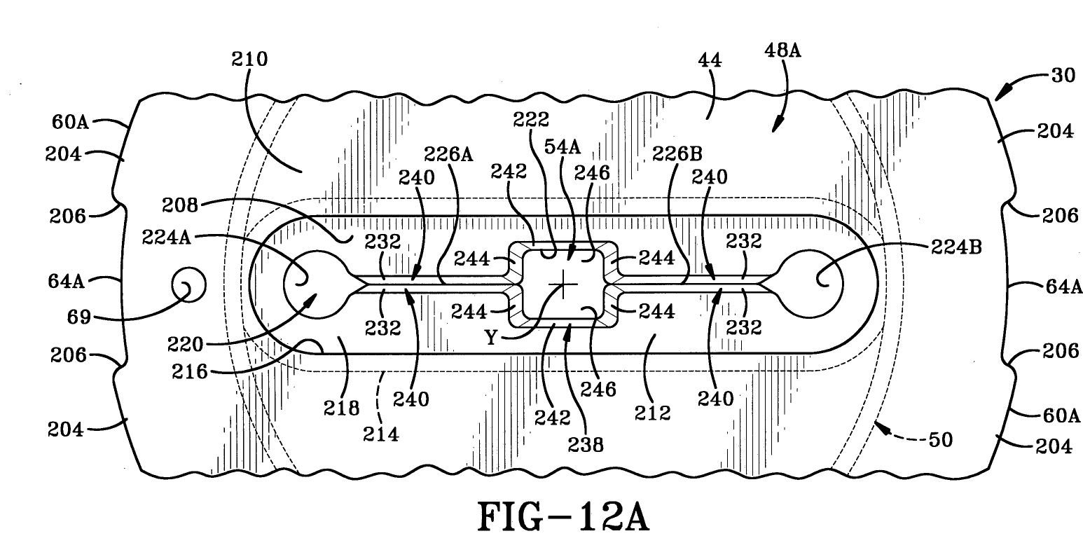

Insert portion 52A includes a pair of engaging members or walls in the form of fingers 228 which are secured to and extend downwardly from recessed wall 212 in a cantilever fashion. Engaging fingers 228 are substantially identical and are positioned in a mirror image relationship with one another. Fingers 228 and the associated portions of recessed wall 212 define therebetween rectangular portion 222 and straight portions 226. Engaging fingers 228 are generally flat and generally vertical although they taper downwardly and inwardly from their connection to recessed wall 212 to lower terminal ends 230, as best seen in FIG. 14. Each finger 228 has an inner side or surface 232 and an opposed outer side or surface 234 whereby the inner surfaces 232 of the respective fingers 228 face one another with axis Y therebetween and the outer surfaces 234 face away from one another and axis Y. Each engaging finger 228 has opposed upwardly extending and generally vertical side terminal edges 236 which extend from inner surface 232 to outer surface 234 and from the top of the respective finger 228 to its bottom terminal end 230. Each engaging finger 228 includes a central U-shaped segment 238 and a pair of substantially flat segments 240 connected to extending laterally outwardly therefrom in opposite directions to respective terminal edges 236. U-shaped segment 238 includes a generally flat base wall 242 which is substantially parallel to flat segment 240 and a pair of short legs 244 connected to and extending between the respective opposed side edges of base wall 242 and the inner edges of the respective flat segments 240. Inner surfaces 232 along respective U-shaped segments 238 define respective U-shaped channels 246 which communicate with one another to form rectangular portion 222. Inner surfaces 232 of respective fingers 228 taper downwardly and toward one another and typically are closely adjacent or abut one another at lower terminal ends 230. Thus, passage 54A includes a wider section 56A adjacent the upper ends of fingers 228 and a narrower portion 58A adjacent terminal ends 230. More particularly, each straight portion 226 tapers downwardly and inwardly as does rectangular portion 222 although rectangular portion 222 at any given height is wider than the corresponding portion of straight portions 226.

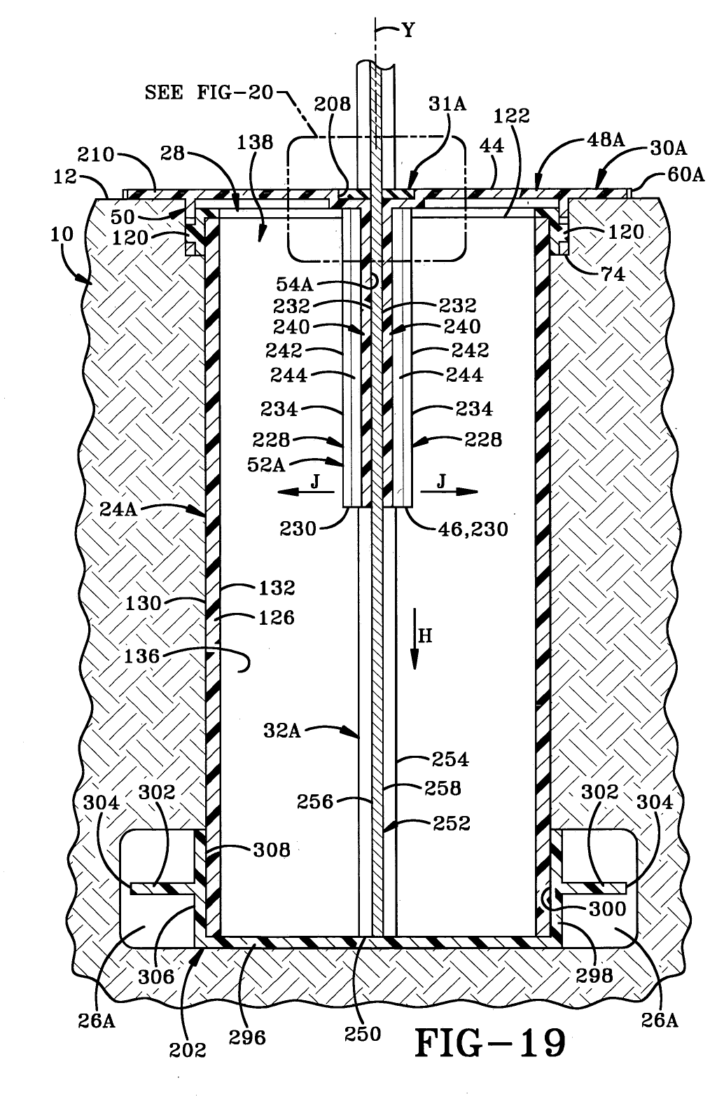

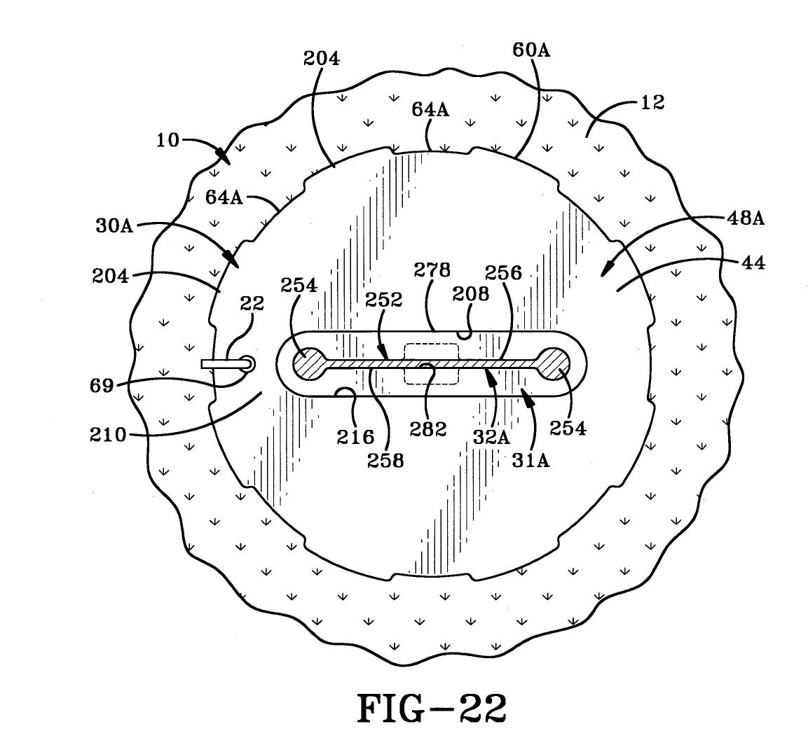

Engaging fingers 228 and recessed wall 212 are configured to form passage 54A so that passage 54A is suitable for slidably receiving therein marker post 32A (FIGS. 11, 15) and marker post 32B (FIG. 16). As previously noted, marker posts 32A and 32B serve the same purpose as marker post 32 although they have a different configuration and more particularly are generally flat. Marker post 32A has a top end 248 (FIG. 11) and a bottom end 250 (FIGS. 19, 21). Marker post 32A has a flat central section 252 which is vertically elongated from top end 248 to bottom end 250. Marker post 32A further includes a pair of circular edge portions or vertical ribs 254 which are secured to the opposed lateral edges of central section or web 252 and likewise extend from top end 248 to bottom end 250. Post 32A has a substantially constant cross section from top end 248 to bottom end 250 and is typically formed by a process of extrusion or pultrusion whereby the latter process pulls reinforcing fibers through a resin bath and die cavity to harden the resin/fiber composite into a substantially rigid structure. Marker post 32A is typically formed as a singularly elongated unitary structure which is impact resistant, flexible, resilient and electrically nonconductive. Marker post 32A may include electrically conductive wires (not shown) extending from top to bottom within ribs 254. Although web 252 is straight as viewed from above, similar marker posts may be formed with a web which is arcuate as viewed from above. Web 252 has front and rear surfaces 256 and 258 defining therebetween a thickness of web 252 which is typically on the order of about ⅛ to ¼ inch. Thus, each of the thicker ribs 254 extends forward of front surface 256 and rearwardly of back surface 258.

Marker post 32B (FIG. 16) is similar to marker post 32A and is thus vertically elongated in a similar manner from a top end to a bottom end. However, the cross section of marker post 32B is somewhat different than that of post 32A. More particularly, post 32B includes a central rib 260, a pair of flat sections or webs 262 connected to an extending outwardly from rib 260 in opposite directions, and a pair of lateral edge ribs 264 secured to the outer edges of flat sections 262 respectively. Central rib 260 and flat sections 262 share a common flat front surface 266. Flat sections 262 have respective back surfaces 268 which are parallel to front surface 266 and define therebetween a thickness similar to the thickness of web 252. In the exemplary embodiment, central rib 260 is generally triangular and extends rearwardly from back surfaces 268 whereby the outer periphery of central rib 260 communicates with back surfaces 268. Lateral ribs 264 extend forward of front surface 266 whereby the outer periphery of each rib 264 communicates with front surface 266 and back surface 268. Thus, in the exemplary embodiment, central rib 260 extends only rearwardly of back surface 268 while lateral ribs extend only forward of front surface 266 whereby no portion of central rib 260 is forward of front surface 266 and no portion of either rib 264 is rearward of back surface 268. Although other marker posts may be formed that are generally similar to marker posts 32A and 32B while having somewhat different configuration of the webs and ribs, markers 32A and 32B are commonly used in the industry.

Referring to FIG. 17, sealing member 31A is now described in greater detail. Generally, sealing member 31A is configured to fit in a mating fashion within recess 208 of cover wall 48A and defines a passage for matingly receiving marker post 32A. Sealing member 31A is shown generally upside down in FIG. 17 in order to illustrate a peel strip 270 which is removably adhered to sealing member 31A by an adhesive layer 272. FIG. 17 illustrates the peeling off of peel strip 270 at arrow H. More particularly, sealing member 31A has flat parallel top and bottom surfaces 274 and 276, an outer edge or periphery 278 which has the same shape and is of substantially the same size as inner periphery 216 whereby outer periphery 278 is configured to matingly engage inner periphery 216, and an inner periphery 280 defining a through opening or passage 282 having the same shape and substantially the same size as the outer periphery of marker post 32A. Adhesive layer 272 is adhered to bottom surface 276 while peel strip 270 is peelably removably connected to adhesive layer 272. Outer periphery 278 of sealing member 31A is generally rectangular and more particularly includes a pair of opposed parallel straight edges 284 which are elongated between and communicate with a pair of convexly curved ends or edges 286 which are substantially semicircular. Straight edges 284 have a mating configuration with the straight edges of inner periphery 216 while curved edges 286 respectively have a mating configuration with the concavely curved semicircular ends of inner periphery 216. Inner periphery 280 includes a pair of parallel straight edges 288 which are adjacent one another and a pair of convexly curved circular edges 290 whereby straight edges 288 define therebetween a straight portion 292 of passage 282 and circular edges 290 define respective circular wider portions 294 respectively at the ends of and wider than straight portion 292. Passage 282 is thus configured to slidably receive marker post 32A with straight edges 288 abutting straight surfaces 256 and 258 and circular edges 290 abutting the respective outer peripheries of ribs 254 whereby inner periphery 280 circumscribes and is in continuous contact all the way around the outer periphery of marker post 32A in order to form a substantially water tight seal therebetween.

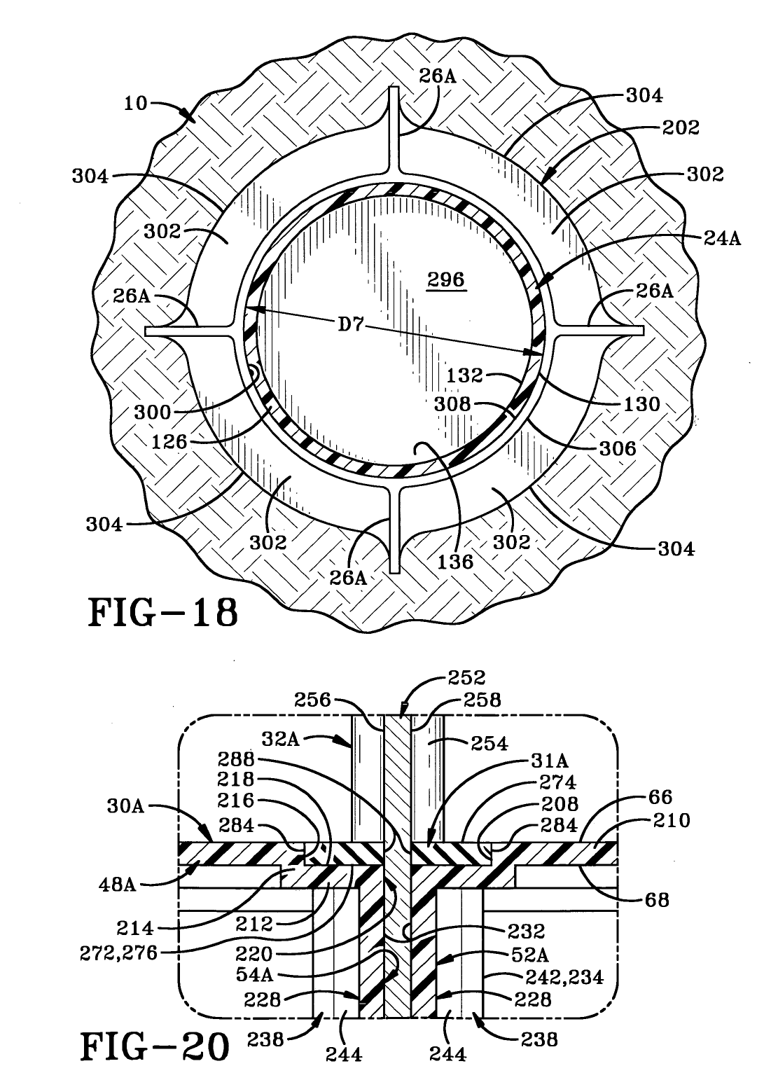

Referring to FIGS. 11, 18 and 19, anti-rotation cuff 202 is described in greater detail. Cuff 202 includes a circular bottom wall 296 and a cylindrical side wall 298 which is rigidly secured to and extends upwardly from the outer perimeter of bottom 296 so that bottom wall 296 and side wall 298 define therewithin an upwardly opening cavity 300 configured to receive therein the bottom end of tube 24A. Anti-rotation fins 26A are rigidly secured to and extend outwardly from the outer periphery of sidewall 298. In the exemplary embodiment, there are four fins 26A which are circumferentially spaced 90 degrees toward one another whereby two of the fins are parallel and coplanar with one another and the other two fins are parallel and coplanar and with one another and perpendicular to the other pair. Arcuate strengthening ribs 302 are rigidly secured to and extend radially outwardly from the outer periphery of side wall 298 respectively between adjacent pairs of fins 26A. Each rib 302 at its circumferentially opposed ends is rigidly secured to a respective adjacent pair of fins 26A. Ribs 302 are flat along a common horizontal plane and extend radially outwardly to a convexly curved terminal edge 304 which is substantially concentric with side wall 298 about axis Y. Ribs 302 are parallel to and spaced upwardly from bottom wall 296. In addition to adding strength to the structure of cuff 202, ribs 302 also provide a reasonably substantial flat upwardly facing surface which serves to inhibit upward movement of tube 224A when buried in ground 10. Side wall 298 has an outer periphery 306 from which ribs 302 and fins 26A extend radially outwardly. Side wall 298 has a circular inner periphery 308 defining a diameter D7 which is the same as the inner diameter of side wall 110 of connector collar 28. Thus, inner periphery 308 is sized to mate with the outer periphery 130 of side wall 126 of tube 24A such that when the bottom end of tube 24A is received within cavity 300, outer periphery 130 is closely adjacent or in contact with inner periphery 308 and the bottom end of side wall 126 is closely adjacent or abuts the top surface of bottom wall 296. Cuff 202 is rigidly secured to the bottom of side wall 126 so that bottom wall 296 serves as the bottom wall of tube 24A and side wall 298 reinforces the bottom portion of side wall 126. Cuff 202 is secured to the bottom of side wall 126 by glue, sonic welding or any other suitable manner which more particularly forms a water tight seal between the lower end of side wall 126 and cuff 202 to prevent water from seeping into interior chamber 136.

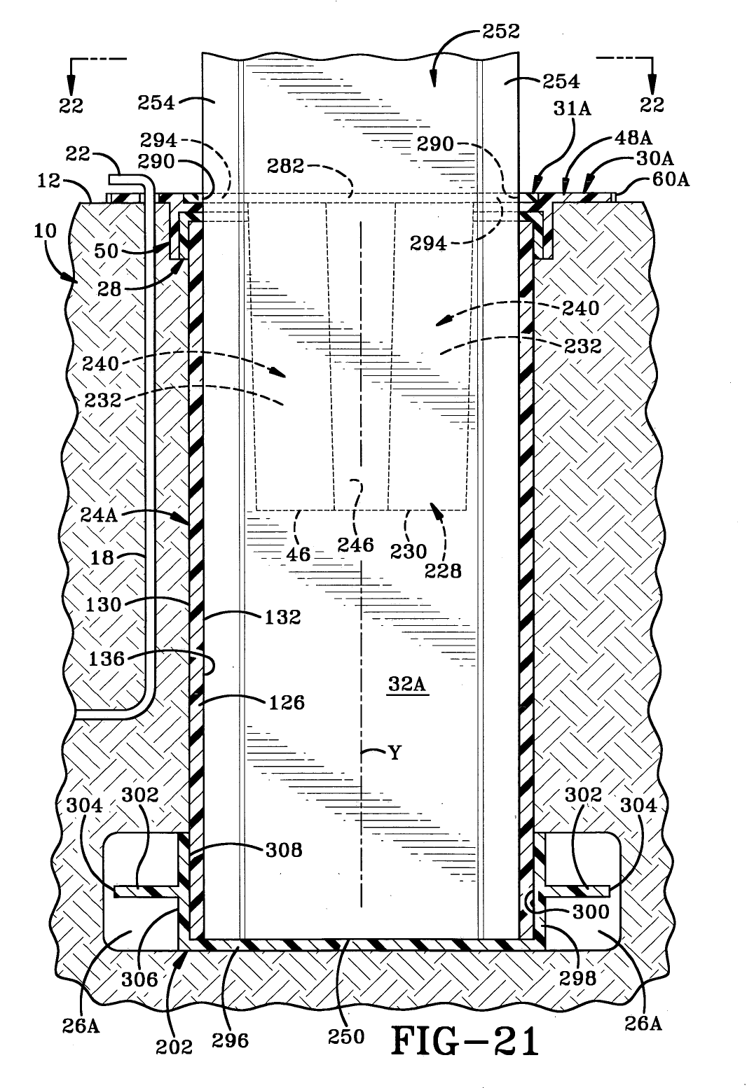

The assembly and operation of marker system 200 is now described with primary reference to FIGS. 19-22. Connector collar 28 is rigidly secured to the top of side wall 126 as described with respect to marker system 1. As with marker system 1, tube 24A is buried in ground 10 so that its upper end is adjacent surface 12 and interior chamber 136 communicates with above ground atmosphere. Holder 30A is connected to connector wall 28 in the same fashion as described with the use of holder 30 in marker system 1. Thus, cover wall 48A extends over interior chamber 136 and connector wall 50 is connected to and circumscribes connector collar 28. Connector wall 50 also circumscribes the upper end of side wall 126 and a portion of interior chamber 136 adjacent the top of side wall 126. During the mounting of holder 30A, insert 52A is inserted downwardly into interior chamber or cavity 136 whereby connector wall 50, connector collar 28 and side wall 126 all circumscribe a portion of insert 52A. Passage 54A is thus disposed within interior chamber 136.

Marker post 32A is then slid downwardly (arrow H in FIG. 19) through passage 282 of sealing member 31A into passage 54A and interior chamber 136. More particularly, passage 282 is configured so that web 252 of marker post 32A is received within rectangular portion 222 and straight portions 226 while ribs 254 are respectively received within circular portions 224A and 224B. Other than rectangular portion 222, passage 282 has a transverse cross sectional shape which is substantially the same as and slightly larger than that of marker post 32A. Thus, during insertion of marker post 32A, ribs 254 may slidably engage the portion of recessed wall 212 defining circular portions 224, and surfaces 256 and 258 of web 252 may likewise slidably engage the portions of recessed wall 212 defining straight portions 226. The central portion of web 252 is received in rectangular portion 222 and thus spaced from flat base walls 242 of U-shaped segment 238. The downward insertion of post 32 forces the lower terminal ends 230 of engaging fingers 228 outwardly in opposite directions (arrows J) from one another radially outwardly with respect to vertical axis Y and transverse to the direction of insertion of post 32A. Terminal ends 230 thus move radially outwardly or spread apart from one another during the insertion of marker post 32A due to the fact that web 252 is wider than the spacing of internal ends 230 when they are at rest (FIG. 14). Engaging fingers 228 thus apply an inward force opposite arrows J to the opposed sides of web 252 of marker post 32A. Surfaces 256 and 258 slidably engage the surfaces 232 of engaging fingers 228 throughout insertion of marker post 32A until the bottom 250 thereof abuts the upper surface of bottom wall 296. Said surfaces also slidably engage inner surfaces 232 on removal of marker post 32A. Once marker post 32A is fully inserted, inner surfaces 232 are substantially vertical and parallel to one another and thus are closely adjacent or abut surfaces 256 and 258 from adjacent the top of fingers 228 to their bottom terminal ends 230. FIG. 21 shows ribs 254 of marker post 32A abutting or closely adjacent inner surface 132 of side wall 126 of tube 24A. However, ribs 254 may be spaced inwardly from surface 132.

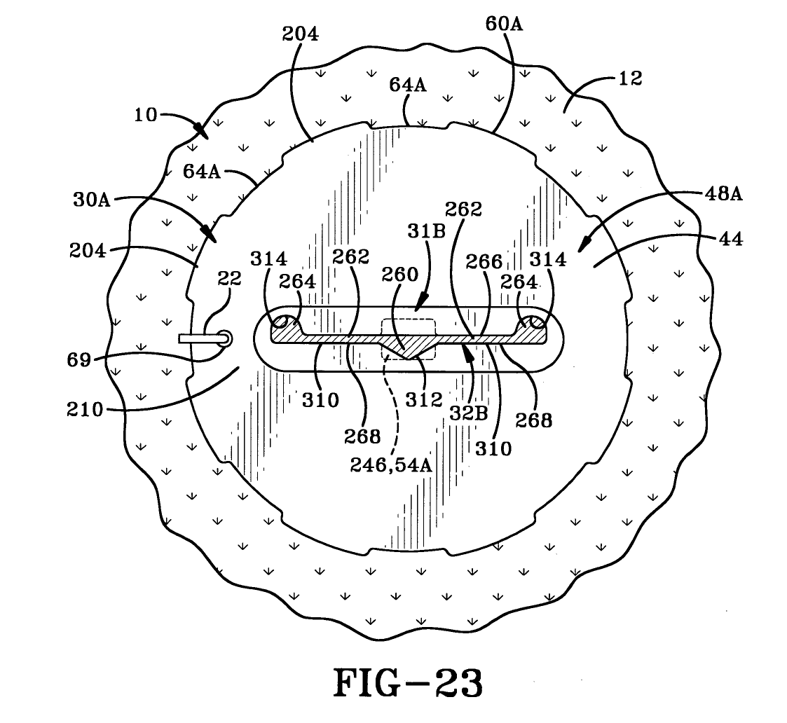

During insertion of marker post 32A, it slidably engages the inner periphery 280 of sealing member 31A as previously discussed and thus forms a water tight seal around the outer periphery of marker post 32A once inserted. In addition, sealing member 31A forms a watertight seal with cover wall 48A of holder 30A as previously discussed. Prior to insertion of marker post 32A, peel strip 270 will have been removed from the back of sealing member 31A to expose adhesive 272 whereupon sealing member 31A is then inserted into recess 208 so that adhesive 272 is adhered to the top of recessed wall 212 to secure sealing member 31A in place. The outer periphery 278 of sealing member 31 thus forms a water tight seal with the inner periphery 216 and adhesive 272 forms a water tight seal with the upper surface of recessed wall 212. The mating engagement between sealing member 31A and each of the outer periphery of marker post 32A and inner periphery 216 is most clearly shown in FIG. 22.

The use of sealing member 31B is shown with marker post 32B in FIG. 23, which is analogous to FIG. 22. Thus, sealing member 31B is received within recess 208 and adhered to the top of recess wall 212 in the same manner as sealing member 31A and receives through its passage marker post 32B in order to form a substantially water tight seal around the outer periphery of marker post 32B in the same manner as previously described. More particularly, the inner periphery of sealing member 31B includes a pair of straight portions 310 which are substantially collinear and extend outwardly from a generally triangular central portion 312 to a pair of circular or semi-circular end portions 314. Straight portions 310 have a mating configuration with and receive flat sections 262 while central triangular portion 312 has a mating configuration with and receives central rib 260, and circular end portions 314 have a mating configuration with and receive lateral ribs 264. Sealing member 31B is thus specifically configured to provide the water tight seal with the outer periphery of marker post 32B. However, sealing member 31B is also configured for use with holder 30A such that holder 30A and sealing member 31B together are configured for slidable insertion of marker post 32B so that the enlarged central rib 260 slides downwardly into one of U-shaped channels 246 of passages 54A and 220. Passage 220 is also configured so that circular portions 224 respectively slidably receive therethrough lateral ribs 264 while straight sections 226 slidably receive therethrough the respective flat sections 262. Marker post 32B thus slidably engages recessed wall 212 in a similar manner as that described previously with respect to marker post 31B except that central rib 260 may also slidably engage one of flat base walls 242 of U-shaped segment 238. Engaging fingers 228 and passages 220 and 54A are thus conveniently configured for use with marker post 32A and 32B. The U-shaped walls of fingers 228 thus provide the U-shaped channel 246 for this purpose and also serve as strengthening ribs which add additional strength to the flat portion of fingers 228.

Marker systems 1 and 200 thus provide improved systems in which marker posts may be removably inserted into a cover or holder in a manner which provides a water tight seal along the upper surface thereof and adjacent surface 12 of ground 10 in order to prevent water from entering interior chamber 136 of the underground tube. In addition, both systems allow for the easy replacement of a broken marker post as described with reference to marker system 1 by the disconnecting of the respective holder from the underground tube and removal therefrom so that the broken portion of the marker post may be removed easily and interior chamber 136 may be easily cleaned of dirt, debris, water and the like. In addition, the present invention allows for holders 30 and 30A to be connected to connector collar 28. Although other types of connectors may be provided adjacent the top of tube 24 or 24A in order to releasably connect the marker post holder thereto, connector collar 28 facilitates the ability to provide a kit which may be used with a standard tube or pipe such as a 4 inch diameter pipe section in order to produce underground tube 24 or 24A. Anti-rotation cuff 202 also facilitates the ability to create a kit for this purpose. Thus, the present invention includes a kit which may comprise one or more of the marker post holders 30 or 30A, connector collar 28, sealing members 31, 31A or 31B, and anti-rotation cuff 202 whereby the user can cut a length of pipe suitable for use as tube 24 or 24A in order to create the marker system used with one of the standard marker posts 32, 32A or 32B or the like. More particularly, the user may simply provide the pipe segment to which cuff 202 is secured to the bottom and collar 28 is secured to the top for subsequent use with the given marker post holder including its sealing member and the removable marker post. Cap 34 (FIG. 1) or the like may also be provided as part of such a kit.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A marker system comprising:
a marker post holder;
a passage formed in the holder and having an upper entrance opening; the passage adapted to removably receive therein a marker post via the upper entrance opening; and
a first connector member carried by the holder and adapted for releasably connecting the holder to a tube with a portion of the holder extending over an upwardly opening interior chamber formed in the tube; the tube adapted to be positioned underground with its interior chamber communicating with above ground atmosphere.

2. The marker system of claim 1 wherein the passage tapers downwardly and inwardly.

3. The marker system of claim 1 further comprising an annular sealing member forming a substantially watertight seal with the holder and defining a through opening which communicates with the passage and is adapted to receive therethrough the marker post to form a substantially watertight seal with the marker post.

4. The marker system of claim 1 further comprising a second connector member adapted to be secured to the tube; and a releasable connection between the first and second connector members.

5. The marker system of claim 4 further comprising an annular wall adapted to be secured to the tube adjacent an upper end thereof; and wherein the second connector member is carried by the annular wall.

6. The marker system of claim 4 further comprising a notch formed in one of the connector members; and a post on the other of the connector members; and wherein the post is received in the notch to form the releasable connection.

7. The marker system of claim 1 wherein the holder comprises a cover wall adapted to extend over the interior chamber; and an annular wall secured to and extending downwardly from the cover wall; the annular wall adapted to be disposed adjacent an upper end of the tube when the holder is connected to the tube.

8. The marker system of claim 7 wherein the holder comprises an insert portion which bounds the passage and which is secured to and extends downwardly from the cover wall radially inwardly of the annular wall; the insert portion adapted to be received in the interior chamber.

9. The marker system of claim 8 wherein the first connector member is carried by the annular wall.

10. The marker system of claim 1 further comprising a plurality of engaging members on the holder which bound the passage; and wherein the engaging members are adapted to engage the marker post when the marker post is disposed in the passage.

11. The marker system of claim 10 wherein the engaging members are resilient engaging fingers which are cantilevered from a portion of the holder.

12. The marker system of claim 10 in combination with the marker post; and further comprising a sliding engagement between the marker post and engaging members during insertion of the marker post into the passage.

13. The marker system of claim 10 in combination with the marker post; and wherein the marker post moves in an insertion direction during its insertion into the passage; and the engaging members move in a direction transverse to the insertion direction during insertion of the marker post into the passage.

14. The marker system of claim 1 in combination with the tube; and further comprising a second connector member mounted on the tube; and a releasable connection between the first and second connector members.

15. The marker system of claim 14 wherein the marker post holder is rotatable about a vertical axis between a connected position in which the first and second connector members are connected to one another and a released position in which the first and second connected members are released from one another; and further comprising at least one anti-rotation member which is mounted on and extends radially outwardly from the tube and which is adapted to prevent rotation of the tube about the vertical axis when the tube is positioned underground and the marker post holder is rotated between the connected and released positions.

16. The marker system of claim 1 wherein the marker post holder is rotatable about a vertical axis between a connected position and a released position; and further comprising a cuff adapted to be secured to the tube; and at least one anti-rotation member which is secured to and extends outwardly from the cuff and which is adapted to prevent rotation of the tube about the vertical axis when the tube is positioned underground and the marker post holder is rotated between the connected and released positions.

17. The marker system of claim 1 in combination with the tube and the marker post; and further comprising a plurality of engaging members within the interior chamber which engage the marker post when inserted into the interior chamber via the passage.

18. The marker system of claim 1 in combination with the tube and the marker post; and further comprising an upper end of the passage; and a broken segment of the marker post in the interior chamber entirely below the upper end of the passage; and wherein the holder is removable from the tube to provide manual access to the interior chamber whereby the broken segment is manually removable from the interior chamber.

19. A marker system comprising:
a tube defining an interior chamber having an upper entrance opening; the tube adapted to be positioned underground with its interior chamber communicating with above ground atmosphere;
a marker post holder releasably connected to the tube and comprising a portion extending over the interior chamber;
a passage formed in the holder adjacent the upper entrance opening; and
an annular sealing member forming a substantially watertight seal with the holder and defining a through opening which communicates with the passage and is adapted to receive therethrough the marker post to form a substantially watertight seal with the marker post.

20. A marker system comprising:
a tube defining an interior chamber having an upper entrance opening; the tube adapted to be positioned underground with its interior chamber communicating with above ground atmosphere;
a marker post holder releasably connected to the tube and comprising a portion extending over the interior chamber;
a passage formed in the holder adjacent the upper entrance opening; and
a plurality of engaging members within the interior chamber adapted to engage a marker post inserted into the interior chamber via the passage.
